(19) United States
(12) Patent Application Publication
(10) Pub. No.: US 2004/0202584 A1
(43) Pub. Date: Oct. 14, 2004

(54) Biosafty cabinets for use in vitro fertilization

(76) Inventor: Catherine Poirot, Paris (FR)

Correspondence Address: YOUNG & THOMPSON, 745 SOUTH 23RD STREET 2ND FLOOR, ARLINGTON, VA, 22202

(21) Appl. No.: 10/629,557

(22) Filed: Jul. 30, 2003

Related U.S. Application Data
(63) Continuation of application No. PCT/FR02/00346, filed on Jan. 29, 2002.

(30) Foreign Application Priority Data
Jan. 30, 2001 (FR) 01/01250

(51) Int. Cl. B01L 9/00

(52) U.S. Cl. 422/104

(57) ABSTRACT

The invention concerns the field of microbiological security stations for manipulating microscopic samples under visual control. More particularly, the invention concerns microbiological security stations adapted to the handling of biological organisms, and particularly for in vitro fertilization, without being exclusive to that particular field of application. The inventive microbiological security station is essentially characterised in that there is incorporated in the body of the station an optical system enabling to observe a sample placed in the chamber, so as to clear to a maximum the workspace, but also so as to make it possible to clean rapidly and completely the internal volume of the chamber.

The invention relates to the field of biosafety cabinets (hereinafter designated by the acronym BSC) for handling microscopic samples under visual control. More particularly, the invention relates to BSCs adapted for handling biological material, in particular for in vitro fertilization (IVF), but it is not limited to this field.

Handling biological material usually necessitates means for protecting the samples being handled and/or the operator against microbiological risks. Manipulations are generally carried out in horizontal or vertical laminar air flow hoods.

Horizontal laminar flow hoods are chambers in which air from the rear portion of the hood is directed horizontally towards the front portion thereof, which is largely if not entirely open. The operator is placed in front of that open portion and as a result is exposed to splashes from the sample which is being handled and/or processed. In that configuration, the operator is not protected from possible contamination.

The operator is protected when using a biosafety cabinet (BSC); the simplest model (type I BSC) has a flow of air entering the hood and a system for filtering the expelled air. However, samples handled in a type I BSC are not protected.

In vertical laminar flow hoods, the flow derives from the roof of the hood and falls towards the work surface. The front portion of such hoods has protective glass to prevent splashes from leaving it. Thus, such hoods constitute biosafety cabinets as they protect the operator. Vertical laminar flow hoods belong to the class II BSC category as they protect the sample, the operator and the environment when equipped with a system for filtering expelled air.

Certain types of microbiological manipulations require magnified observation of the sample being handled and thus require the use of a binocular magnifying glass or a microscope. Introducing such a device into a laminar flow hood perturbs the flow and thus reduces the efficiency of the hood. It is particularly difficult (or even impossible) to use a binocular magnifying glass or a microscope in a vertical flow hood because of the protective glass located at the front face of the hood. Further, introducing equipment into the work space of a hood makes cleaning said work space difficult and thus increases the risk of contamination between the various samples that are handled.

Thus, currently available BSCs and horizontal laminar flow hoods do not enable biological samples to be handled under visual control using a magnifying device under conditions that ensure microbiological safety of the sample and the operator and also wherein the work space is easy to clean.

The present invention aims to overcome at least some of the disadvantages cited above.

The present invention pertains to a biosafety cabinet (BSC) comprising walls defining a work space, provided with an optical device placed outside the work space and allowing observation of a sample in at least one zone of the work space via a transparent window that is integral with one of said walls.

In a particular embodiment of the invention, the BSC comprises a plate for receiving the sample in the observation zone of the work space, said plate comprising a first transparent window W1 for illuminating and/or observing the sample.

Further, the floor of the work space of a BSC of the invention comprises one or more zones provided with temperature regulating means that can be thermostatted to a temperature in the range 20° C. to 45° C., in particular 37° C.±0.2° C. In particular, the plate P mentioned above can be equipped with said temperature regulating means.

In BSCs of the invention, the optical observation device preferably comprises illumination means for illuminating the sample in the observation zone and light collecting means allowing a sample placed in said observation zone to be observed. All of said means can be located beneath the floor of the work space to illuminate and observe the sample from below, through the window W1 of the plate. Alternatively, all or part of the illumination means and/or the light collecting means can be located behind one or more other windows supplied in at least one of the walls, for example in the upper wall (roof) opposite the floor.

The light collecting means of the BSC of the invention preferably comprises an autofocusing camera. In order to observe microscopic samples, this camera is preferably arranged to provide several image magnifications between 10 and 1000, in particular between 10 and 400, and if appropriate only between 10 and 70.

In a preferred embodiment of the BSC of the invention, the optical light collecting device (for example the self-focusing camera) further comprises a system for fine adjustment at each magnification, which can advantageously be controlled from a control panel located outside the work space and/or integral with one of the walls defining the work space. As an example, the control panel can be located on the front face outside the hood or in the form of touch control keys formed on a screen incorporated into the floor of the hood, for example to the left of the work and observation stations.

The light collecting device of the BSC of the invention is preferably connected to a device for recording the collected images, such as a computer provided with data storage means such as a hard disk or a removable storage device.

In a preferred embodiment, the BSC of the invention comprises an observation screen S integral with one of the walls defining the work space, said screen allowing the images collected by the light collecting means to be viewed. Said observation screen can, for example, be a flat screen integrated with the back wall of the work space.

In a particular embodiment of the invention, the BSC can further comprise a sample gassing zone comprising a gas inlet, a chamber for confining gas and a connection device connecting said gas inlet to said chamber. Preferably, the chamber and the connection device can be readily dismantled, and more preferably, the chamber and the connection device are separate pieces of the disposable type. In this embodiment of the invention, the gas inlet is preferably integral with one of the vertical walls defining the work space, and the chamber is a transparent bell jar connected to the gas inlet via a tube. The connection device connecting the gas inlet to the chamber advantageously comprises a protective flange to protect the gas inlet from splashes.

In a further embodiment, the BSC of the invention comprises a data acquisition device. This data acquisition device can consist of a touch keypad integral with the floor of the hood and connected to a computer. Alternatively, the keypad can be located outside the work space on the front face of the hood. If necessary, a file of data being recorded can be displayed on screen S mentioned above or on a portion of this screen. Alternatively, a second specific screen can be integrated into a wall of the work space.

The floor and the vertical walls defining the work space of a BSC of the invention are preferably flat and constituted by smooth, washable materials that are resistant to the cleaning products used in laboratories, such as products containing quaternary ammonium compounds or the most powerful virucides. Alternatively, and/or in complementary manner, the floor is constituted by one or more elements that can be dismantled and are disposable or can be sterilized in an autoclave.

Other characteristics and advantages of the invention will become apparent from the following detailed description and drawings in which:

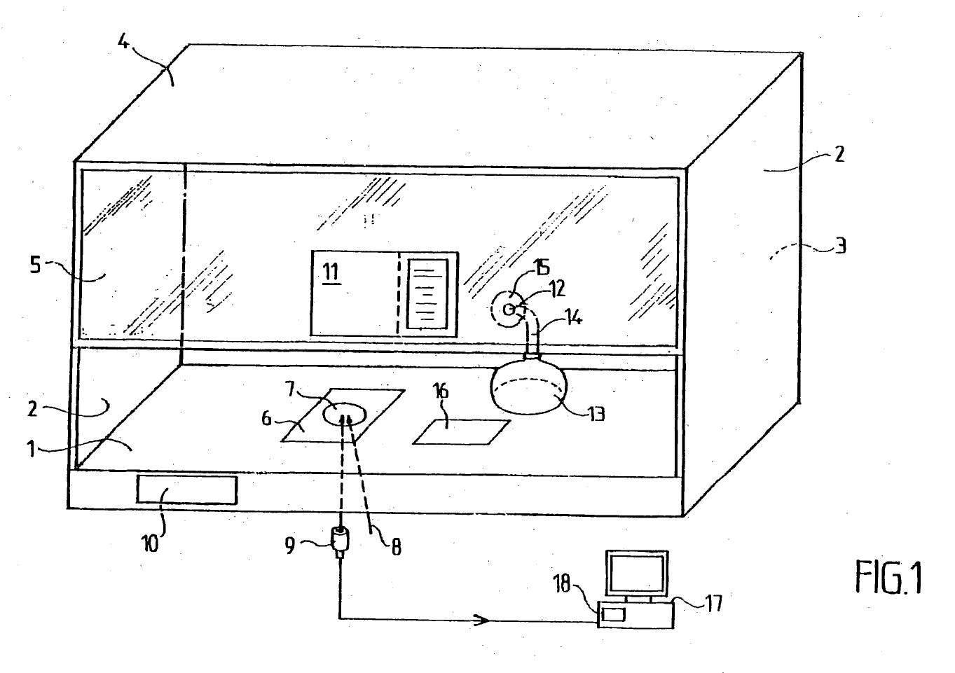

FIG. 1 is a highly diagrammatic perspective view of a biosafety cabinet (BSC) of the invention;

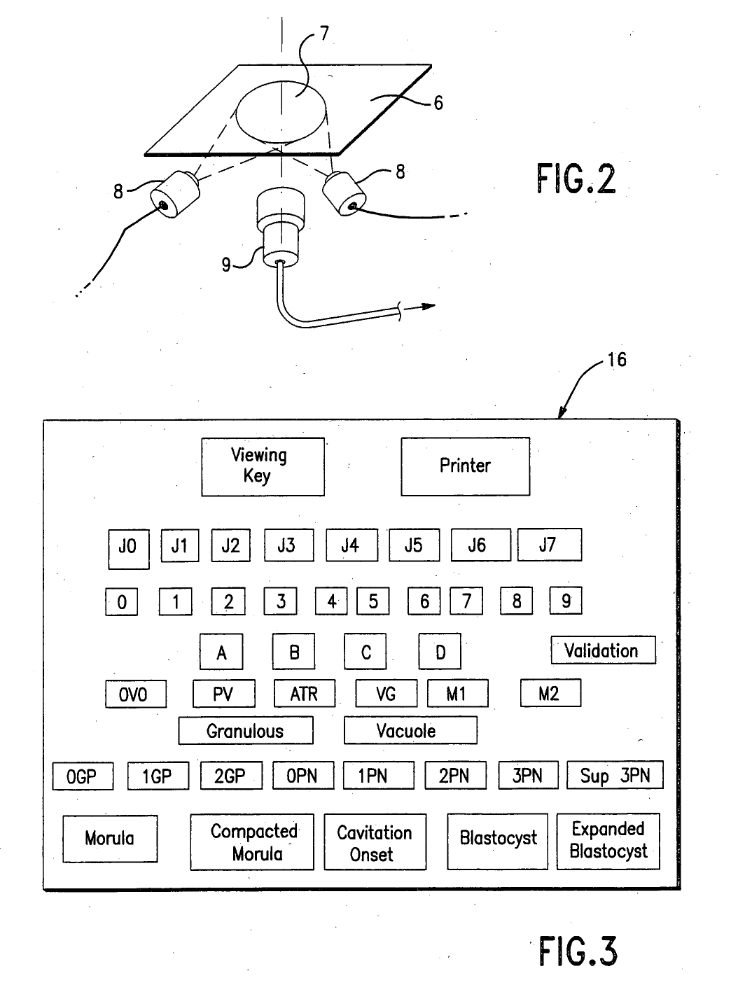

FIG. 2 is a diagram of a portion of the optical device of the BSC of FIG. 1; and

FIG. 3 shows an example of a data acquisition keypad

The present invention concerns a BSC (as defined in the introduction) comprising a plurality of elements that cooperate in an original manner to provide easy handling under visual control of microscopic objects under conditions that ensure the protection of the handled objects and of the operator against microbiological risks. This invention can be used in any type of application necessitating microbiological protection of handled objects and/or an operator. Examples that can be cited are the production of sterile equipment, biological or cell therapy research (for example for the preparation of corneas for grafting) and for handling embryos or stem cells. One particular application for this invention is in vitro fertilization.

Assisted reproductive techniques (ART) are designed to conceive human beings and are also employed in the veterinary field.

In vitro fertilization (IVF) is aimed at bringing together the ovocyte (female gamete) and spermatozoid (male gamete) outside the organism (in vitro).

The different biological steps in IVF are spread over several days (D):

| | |
|---|---|
| D0 | preparation of spermatozoids |
| | find ovocytes in follicular fluid contained in syringes |
| | culture ovocytes |
| | insemination: bring spermatozoids into contact with ovocytes |
| | in culture dishes |
| D1 | the ovocytes are freed one by one from their surrounding cells |
| | (decoronization) to allow microscopic examination for signs |
| | of fertilization (presence of pronuclei) |
| D2 or D3 | observation of first stages of embryonic development |
| | replacing some embryos in the uterine cavity of the patient |
| | using a small catheter |

These operations have to be carried out with great rigor, in particular as regards health and safety. The operators must avoid contaminating the gametes with which they are charged, must ensure embryonic culture that is sterile as regards infections and must avoid cross contamination between samples.

To achieve this, the different steps of in vitro fertilization procedures are carried out in a sterile manner, conventionally in a laminar flow hood. The laminar flow of the hoods is aimed at preventing the introduction of foreign elements that are potential contaminants into the work zone. For optimum efficiency, the work zone must be free of objects that disturb the flow.

However, finding the ovocytes (with a diameter of 150 μm), insemination, decoronization and charging the transfer catheter can only be carried out under visual control, currently using a binocular magnifying glass.

As a result, for all IVF steps except for spermatozoid preparation, which necessitates microscopic monitoring, personnel have to place the binocular magnifying glass under a hood in order to operate under the correct aseptic conditions. Unfortunately, as explained above, using a binocular magnifying glass is incompatible with using a vertical laminar flow hood. In practice, the steps requiring microscopic visual control are carried out by placing the binocular magnifying glass under a horizontal flow hood, which poses three types of problems: firstly, the operator is not protected; secondly, the flow is perturbed, which reduces the efficiency of the hood and thus the degree of protection of the sample; thirdly, cleaning the hood (and the binocular magnifying glass) after handling the sample is lengthy and difficult.

Within the context of IVF, the operator must be protected for at least three reasons:

any sample of human origin must a priori be considered to constitute a risk of infection;

there are maneuvers which carry a risk of contamination, such as possible splashing of biological liquids during examination of follicular fluids, which fluids are often quite bloody;

finally, some legislations tend to preclude patients with certain diseases from assisted reproductive technique protocols. As an example, in France, the Bioethics Law dated 24^{th} Jul. 1994 obliges personnel to check for the blood diseases HIV, hepatitis B and C and syphilis in all patients who may benefit from ARTs. Infected patients can no longer be treated.

The pressure on couples at least one of whom is infected with one of the viruses mentioned above (hepatitis B, hepatitis C, HIV, syphilis) has become such that some research protocols for treating patients or infected patients have been drawn up. In certain hospitals, such as the Hôpital Cochin (Paris, France), couples who differ serologically for the AIDS virus are treated, in the context of a protocol financed by the ANRS (Association Nationale de Recherche contre Sida) [National Association for AIDS Research]. Couples with a seropositive male patient and a seronegative female patient are treated. Couples with a seropositive female patient are not treated because of the risk of contaminating the operators because said operators work in a horizontal laminar flow hood when handling the female gametes. Further, certain ART laboratories will not treat couples infected with heptatis C virus, for the same reasons.

In order to be able to respond to these demands and to protect the operator, it is thus indispensable to be able to carry out all of the ART steps in biosafety cabinets (BSC), for example in vertical laminar flow hoods.

Further, taking on patients who are seropositive for a dangerous virus means that the work space in which the samples are handled must be systematically and completely sterilized after treating each sample. Nosocomial contamination between patients treated under ART protocols must be completely avoided. Contamination of this type has been described (Lesourd et al, Human Reproduction, 2000, vol 15, n° 5, pp 1083-1085), emphasizing the attention that must be paid to this problem.

That type of nosocomial contamination has two main origins:

Firstly, inter-sample contamination can come from the operator (following splashing from a sample onto a coat, for example) or from objects used by the operator, such as pencils or notebooks.

The second possible cause of inter-sample contamination is imperfect cleaning of the hood and its contents. The risk of contamination by the hood and the instruments used in the hood increases with the number of objects in the hood and with increasing complexity of the object shape. Thus, a binocular magnifying glass, with a plate, several objectives, lamps and adjusting knobs, is an instrument that is particularly hard to clean in a manner that ensures sterility.

In practice, while complete cleaning of the hood takes a long time, which is incompatible with the constraints of treating a number of samples every day in the cabinet, cleaning will be imperfect. Encumbering the work space with objects required for the operations is thus a problem on two counts: firstly, it disturbs the efficiency of the hood by disturbing laminar flow, and secondly, it renders sterilization of the hood lengthy and difficult and in practice frequently imperfect.

In this context, then, there is a great need for a biosafety cabinet that is adapted for the needs of IVF, i.e. simultaneously protecting the sample, the operator and the environment, and which allows microscopic observation of gametes and embryos while reducing the risk of cross-contamination. The constraints linked to the nature of IVF operations are encountered when handling other biological samples, in particular operations involving human or animal cells for research, cell therapy, gene therapy or embryo research. A biosafety cabinet that is suitable for IVF is hence suitable for those other manipulations. Ideally, such a BSC will be easy and quick to clean and will not necessitate introducing into the hood equipment other than consumables or, if appropriate, which can be sterilized in an autoclave.

The BSC of the invention can satisfy at least a portion of said constraints. An essential and original point of the BSC of the invention is integration, in the body of the BSC, of all of the equipment necessary for in vitro fertilization, in particular the optical system, in order to clear out the work space as far as possible to obtain a good level of protection of the sample and the operator, and also so that the interior of the hood can be rapidly and completely cleaned between each sample, thus reducing the risk of contamination between samples.

The BSC of the invention can be type I, type II or even type III. Type III BSCs are chambers with a confined atmosphere maintained at an under-pressure, in which operations are carried out using gloves sealed in the chamber. Integrating the optical equipment into the body of such a BSC forms a part of the present invention. In general, integrating the optical equipment into the body of any biosafety cabinet to obtain as clear a work space as possible forms a part of the invention. Preferably, the BSC is a type II BSC, for example a vertical laminar flow hood.

In a preferred embodiment of the BSC of the invention, shown in FIG. 1, the work space is defined by the floor 1 of the hood, the side walls 2, the hood rear 3, its roof 4 and a front protective glass 5. It also comprises a plate 6 for receiving the sample in an observation zone in the work space, said plate comprising a first transparent window 7 for illuminating and/or observing said sample.

In this embodiment of the invention, the optical observation device comprises illumination means 8 for illuminating the sample in the observation zone and light collecting means 9 for observation of a sample placed in said zone.

The optical device is preferably a video system that can store images, for example an autofocusing camera 9 connected to an image recording device such as a computer 17 provided with data storage means 18. The cameras can be of the digital or analogue type. Preferably, the video system essentially comprises optics 9 for collecting photons from the observation zone and a system for controlling the adjustments for focus, illumination 8 and magnification. The optics can be inverted to allow them to be fixed beneath the work surface 1 (floor of the hood). The majority of technical maneuvers are carried out at relatively low magnifications (about 10 to 70). However, a more powerful optical system allowing magnifications of up to 400 or more can be used to observe zygotes and embryos at D+2 or D+3 or even up to D+6. To this end, a tri CDD ½ inch camera can be used to observe a 125 μm object on a 17″ (inch) screen, giving a size of about 100 mm.

Alternatively, other types of image collecting devices can be used. A non-limiting example that can be cited is charge coupled devices (CCD) used as a bar code reader.

The optical element 9 can be placed beneath the floor 1 of the hood facing a transparent window 7, preferably integrated into the plate 6 as shown in FIGS. 1 and 2. Preferably again, plate 6 located around said window 7 is a heating zone.

Other dispositions can be envisaged for the optical system. As an example, at least a portion of the illumination means and/or light collecting means can be located behind one or more windows integral with at least one of the walls and distinct from window 7. In particular, certain elements, in particular light collection elements, can be placed on the roof 4 of the hood, facing the observation zone.

In a particular embodiment of the invention, the observation zone assembly is illuminated by a device 8 termed a “long field lens” device by adding a condenser placed at about 182 mm from the sample. This system comprises an optic fiber fixed to one end of a stainless steel tube which itself is integral with the wall of the cabinet. The power of the light generator is 150 W, for example, and can preferably be adjusted. Clearly, any other illuminating means that is known to the skilled person can be used to illuminate the work zone and observe the sample.

In a particular embodiment of the invention, the apparatus assembly is controlled from a pedal located on the ground beneath the cabinet, adjustments being made by pressing on the pedals used for each of the functions. The drive system comprises, for example, three pairs of pedals placed on an inclined support:

2 positional adjustment pedals;

2 zoom pedals;

2 illumination pedals.

Clearly, other control systems can be envisaged. As an example, fine adjustment of the position can be made by keys that can be actuated by the fingers on a control panel 10 placed at the front of the hood to the left of the sample observation zone as shown in FIG. 1. The zoom and illumination can also be adjusted from this control panel.

If appropriate, a control panel placed outside the hood comprises a device for adjusting the motor speed, for example a potentiometer (adjustment preferably being made before the operator introduces his/her hands into the stream).

Preferably, the BSC of the invention comprises an observation screen 11 integral with one of the walls defining the work space, said screen allowing images collected by the light collecting device 9 to be displayed. Preferably again, the observation screen 11 is a flat screen integral with one of the vertical walls 2 or 3 of the hood, for example the rear wall 3 of the work space behind the sample observation zone.

Further, there are other general provisions to ensure optimum quality of the IVF technique. Firstly, the temperature at which the operations are carried out must be maintained at around 37° C., which means that the work surface must be thermostatted at about 37° C. To this end, the floor 1 of the work space can comprise one or more zones provided with temperature regulating means, to thermostat it at a temperature in the range 20° C. and 45° C., in particular 37° C.±0.2° C. In particular, plate 6 can be provided with said temperature regulating means. As an example, they may be resistances placed beneath the plate 6 and as a result outside the work space. If necessary, the whole of the floor of the work space could be thermostatted.

A further important constraint in IVF is to maintain the pH of the culture media at about 7-7.2 in order not to alter the viability of the gametes and embryos. Said cells do not tolerate Hepes type buffers well, and so the pH is maintained by the presence of bicarbonate in the culture media and a 5% CO₂ gassing system to equilibrate these media. Between two operations on the sample, said sample is thus preferably placed in a chamber 13 maintained under about 5% C0₂. This chamber 13 can, for example, be constituted by a bell jar connected to a gas inlet 12 via a tube 14. In order to reduce the risk of inter-sample contamination mentioned above, said bell jar can be replaced after treating samples from each patient. To this end, either autoclavable jars (for example formed from glass) which must systematically be cleaned after use, or disposable jars, for example thin disposable consumables, can be used. Tube 14 is preferably disposable, but it may also be reusable following sterilization in an autoclave or any other means known to the skilled person.

In one aspect of the invention, a protective flange 15 is provided to protect the gas inlet 12 from any splashes of biological liquid or from aerosols. A gas inlet inevitably disturbs the plane of the wall into which it is integrated and may thus be difficult to clean.

Tools and protocols that can reduce the number of objects required in the hood when processing a sample are also proposed with the common aim of limiting the risk of nosocomial contamination between samples and/or patients. A system for capturing the observed data intended to replace the current “laboratory bench sheet” can be integrated into the BSC. Data can be recorded without using a conventional keypad, which would not satisfy health and safety regulations. A number of types of data capture means can be envisaged. A first possibility is to integrate into the work surface of the hood a touch keypad 16 composed of predefined keys. A second possibility consists of using a screen displaying predefined keys to which a pointer can be directed. The screen is preferably integral with one wall of the BSC. It may, for example, be an observation screen (11) or an active window thereof. Alternatively, it may be a screen that is distinct from (11). The pointer can be moved and keys actuated using a track pad or, more generally, using a mouse. Any other means that is known to the skilled person can also be used to capture the data regarding the processed samples.

These data capture means (touch keypad, track pad or the like) are, for example, located to the left of the optical system (opposite to that shown in FIG. 1). A means for “deactivating” the capture means must be provided to avoid entering false data when cleaning the work surface of the hood. A possible list of predefined keys for a keypad 16 is given below:

| | | | | | | |
|---|---|---|---|---|---|---|
| Days: | D1 | D2 | D3 | D4 | D5 | D6 |

Numbers

Bench sheet viewing key

Validation key

Predefined keys:

Ovocyte

Empty pellucida

Atretic ovocyte

GV

M1

M2

0PB

1PB

2PB

0PN

1PN

2PN

3PN

Sup 3PN

Granulous

Vacuole

(Type) A

(Type) B

(Type) C

(Type) D

Morula

Compacted morula

Cavitation onset

Blastocyst

Expanded blastocyst

An example of an arrangement of the keys on said keypad is shown in FIG. 3.

The data capture system can be connected to a laboratory system from which the patient's identity associated with the samples to be processed and the nature of the treatment can be obtained. The file for the couple to whom the sample to be processed belongs can be called up and viewed on the hood's screen, for example by using the treatment number. It may be a 6 figure number (for example: 990123). Thus, the keypad should also include numerical keys.

Two cases can be envisaged:

1-the camera cannot observe zygotes and embryos;

2-the cameral can observe zygotes and embryos.

In the first case, the data can be recorded in a single day.

When the operator presses a predefined key on keypad 16, the corresponding data is written to the bench sheet. A key for viewing the bench sheet can cause it to appear on screen 11 if needed, in a predefined space on the screen if required.

In the second case in which the camera can observe zygotes and embryos, the day keys are required.

The data is then recorded over several days (3 to 8 days).

Thus, the bench sheet for the corresponding couple has to be recalled in order to continue entering data. As an example, the number of the treatment can be used to pull up the bench sheet, the key corresponding to the day (eg: D1 or D2) allows data to be entered in the correct column. Numerical data can be entered into the boxes on the bench sheet such as the quotation for spermatozoid survival at 24 hours. One example of a possible keypad is shown in FIG. 3.

Walls 1, 2, 3, 4 and 5, defining the work space, are preferably flat and constituted by smooth materials which are washable and resistant to cleaning products such as products containing quaternary ammonium compounds or the most powerful virucides. Alternatively, and/or in complementary manner, the floor can be constituted by one or more elements that can be dismantled and which are disposable or sterlizable in an autoclave or using any other means.

1. Biosafety cabinet (BSC) comprising walls (1-5) defining a work space, characterized in that it comprises an optical device placed outside the work space and allowing observation of a sample in at least one zone of the work space via a transparent window that is integral with one of said walls.

2. BSC according to claim 1, characterized in that it comprises a plate (6) for receiving the sample in said observation zone of the work space, said plate comprising a first transparent window (7) for illuminating and/or observing said sample.

3. BSC according to claim 1, characterized in that the floor (1) of the work space comprises one or more zones provided with temperature regulating means for thermostatting to a temperature in the range 20° C. to 45° C., in particular 37° C.±0.2° C.

4. BSC according to claim 2, characterized in that the plate (6) is provided with temperature regulating means to fix the temperature at its surface between 20° C. and 45° C., in particular 37° C.±0.2° C.

5. BSC according to claim 1, characterized in that the optical observation device comprises illumination means (8) for illuminating the sample in the observation zone and light collecting means (9) allowing a sample placed in said zone to be observed.

6. BSC according to claim 5, characterized in that the light collecting means (9) comprises an autofocusing camera.

7. BSC according to claim 5, characterized in that the light collecting means are placed beneath the first window (7) of the plate (6).

8. BSC according to claim 5, characterized in that all or a portion of the illumination means and/or light collecting means are located behind one or more windows distinct from the first window (7) and integral with at least one of the walls, in particular the upper wall (4).

9. BSC according to claim 5, characterized in that the light collecting device (9) is arranged to allow a plurality of image magnifications of between 10 and 1000, in particular between 10 and 400.

10. BSC according to claim 9, characterized in that the light collecting means (9) further comprise a system for fine adjustment at each magnification.

11. BSC according to claim 10, characterized in that the fine adjustment system is controlled from a control panel (10) located outside the work space and/or integral with one of the walls defining the work space.

12. BSC according to claim 5, characterized in that the light collecting means (9) are connected to a device for recording the images collected.

13. BSC according to claim 12, characterized in that the image recording device is a computer provided with data storage means.

14. BSC according to claim 5, characterized in that it comprises an observation screen (11) integral with one of the walls defining the work space, said screen allowing the images collected by the light collecting means (9) to be viewed.

15. BSC according to claim 14, characterized in that the observation screen (11) is a flat screen integrated with the rear wall (3) of the work space.

16. BSC according to claim 1, characterized in that it further comprises a sample gassing zone comprising a gas inlet (12), a chamber for confining gas (13) and a connection device (14) connecting said gas inlet (12) to said chamber (13).

17. BSC according to claim 16, characterized in that the chamber (13) and the connection device (14) connecting the gas inlet (12) to said chamber (13) can readily be dismantled.

18. BSC according to claim 17, characterized in that the chamber (13) and the connection device (14) connecting the gas inlet (12) to said chamber (13) are separate parts.

19. BSC according to claim 16, characterized in that the gas inlet (12) is integral with one of the vertical walls (2) and (3) defining the work space, and in that the chamber (13) is a transparent bell jar connected to the gas inlet (12) via a tube.

20. BSC according to claim 16, characterized in that the connection device (14) connecting the gas inlet to the chamber comprises a protective flange (15) to protect the gas inlet (12) from splashes.

21. BSC according to claim 1, characterized in that it further comprises data capture means.

22. BSC according to claim 21, characterized in that said data capture means comprise a touch sensitive keypad (16) integral with the floor (1) defining the work space.

23. BSC according to claim 21, characterized in that said data capture means comprise a screen and a track pad controlling a pointer, said track pad being integral with the floor (1) and said pointer being able to activate predefined keys appearing on the screen.

24. BSC according to claim 21, characterized in that the data capture means are connected to a computer.

25. BSC according to claim 1, characterized in that the walls (1-5) defining the work space are flat and constituted by smooth washable materials that are resistant to cleaning products.

26. BSC according to claim 1, characterized in that the floor (1) is constituted by one or more elements that can be dismantled and are disposable or sterilizable in an autoclave.
